(19) United States
(12) Patent Application Publication
(10) Pub. No.: US 2025/0249559 A1
(43) Pub. Date: Aug. 7, 2025

(54) SOCKET STRUCTURE

(71) Applicant: KABO TOOL COMPANY, Taichung City (TW)

(72) Inventor: Chih-Ching HSIEH, Taichung City (TW)

(21) Appl. No.: 19/021,059

(22) Filed: Jan. 14, 2025

Related U.S. Application Data
(60) Provisional application No. 63/550,263, filed on Feb. 6, 2024.

(51) Int. Cl. B25B 23/00; B25B 13/06

(52) U.S. Cl. CPC B25B 23/0035; B25B 13/065

(57) ABSTRACT

A socket structure includes a socket body and a polygonal driving structure. The socket body includes a first fitting hole and a second fitting hole. The first fitting hole and the second fitting hole are respectively located at two ends of the socket body along a central axis of the socket structure, and the first fitting hole is communicated with the second fitting hole. The polygonal driving structure is disposed around an outer peripheral wall of the socket body and surrounds the first fitting hole. The socket structure has a maximum height along the central axis, the polygonal driving structure has an axial height along the central axis, and the axial height is smaller than or equal to half of the maximum height.

### RELATED APPLICATIONS

This application claims priority to U.S. Provisional Application Ser. No. 63/550,263, filed Feb. 6, 2024, which is herein incorporated by reference.

### BACKGROUND

### Technical Field

The present disclosure relates to a socket structure. More particularly, the present disclosure relates to a socket structure which can be driven to pivot by many types of hand tools.

### Description of Related Art

With the progress of science and technology, when operating fasteners such as screws, user often uses socket engaging with the hand tools to disassemble the fasteners, so as to achieve the effects of saving efforts and increasing the convenience of operation. For example, the user can engage the socket with the fasteners, and then use a wrench to hold the socket and drive the socket to pivot by the wrench, so as to complete the disassembly and assembly of the fasteners.

Although there are many types of sockets on the market that can be used with different hand tools, one type of socket can only be driven by one type of hand tool. In different usage scenarios, different sockets and hand tools still need to be used, and the user must prepare multiple sets of sockets to cope with different field constraints, resulting in inconvenience of operation and burden of carrying.

In view of this, how to improve the diversity of driving the socket to pivot has become the goal of relevant industries.

### SUMMARY

According to one embodiment of the present disclosure, a socket structure includes a socket body and a polygonal driving structure. The socket body includes a first fitting hole and a second fitting hole. The first fitting hole and the second fitting hole are respectively located at two ends of the socket body along a central axis of the socket structure, and the first fitting hole is communicated with the second fitting hole. The polygonal driving structure is disposed around an outer peripheral wall of the socket body and surrounding the first fitting hole. The socket structure has a maximum height along the central axis. The polygonal driving structure has an axial height along the central axis, and the axial height is smaller than or equal to half of the maximum height.

According to another embodiment of the present disclosure, a socket structure includes a socket body, a polygonal driving structure and a driving hole. The socket body includes a first fitting hole and a second fitting hole. The first fitting hole and the second fitting hole are respectively located at two ends of the socket body along a central axis of the socket structure, and the first fitting hole is communicated with the second fitting hole. The polygonal driving structure is disposed around an outer peripheral wall of the socket body and surrounding the first fitting hole. The driving hole is communicated with the first fitting hole or the second fitting hole along a radial direction of the central axis.

### BRIEF DESCRIPTION OF THE DRAWINGS

The present disclosure can be more fully understood by reading the following detailed description of the embodiment, with reference made to the accompanying drawings as follows:

FIG. 1 is an exploded schematic view of a socket structure according to the first example of the present disclosure.

FIG. 2 is a three-dimensional schematic view of the socket structure according to FIG. 1.

FIG. 3 is a side schematic view of the socket structure according to FIG. 1.

FIG. 4 is one three-dimensional schematic view of a socket structure according to the second example of the present disclosure.

FIG. 5 is another three-dimensional schematic view of the socket structure according to FIG. 4.

FIG. 6 is a three-dimensional schematic view of a socket structure according to the third example of the present disclosure.

FIG. 7 is a three-dimensional schematic view of a socket structure according to the fourth example of the present disclosure.

FIG. 8 is a three-dimensional schematic view of a socket structure according to the fifth example of the present disclosure.

FIG. 9 is a three-dimensional schematic view of a socket structure according to the sixth example of the present disclosure.

FIG. 10 is a top schematic view of a driving surface and a polygonal driving structure according to the seventh example of the present disclosure.

FIG. 11 is a top schematic view of a driving surface and a polygonal driving structure according to the eighth example of the present disclosure.

FIG. 12 is a top schematic view of a driving surface and a polygonal driving structure according to the ninth example of the present disclosure.

FIG. 13 is a top schematic view of a driving surface and a polygonal driving structure according to the tenth example of the present disclosure.

FIG. 14 is a top schematic view of a driving surface and a polygonal driving structure according to the eleventh example of the present disclosure.

FIG. 15 is a top schematic view of a driving surface and a polygonal driving structure according to the twelfth example of the present disclosure.

FIG. 16 is a top schematic view of a driving surface and a polygonal driving structure according to the thirteenth example of the present disclosure.

FIG. 17 is a top schematic view of a driving surface and a polygonal driving structure according to the fourteenth example of the present disclosure.

FIG. 18 is a top schematic view of a driving surface and a polygonal driving structure according to the fifteenth example of the present disclosure.

### DETAILED DESCRIPTION

A number of examples of the present disclosure will be described below with reference to the accompanying drawings. The following description will include many practical details in order to be clear and specific. The reader, however, should understand that those practical details are not intended to be restrictive of the scope of the invention; in other words, the practical details are not essential to some embodiments of the invention. Besides, for the sake of simplicity of the drawings, some conventional or commonly used structures and elements are drawn only schematically in the drawings, and repeated elements may be indicated by the same reference numeral or similar reference numerals.

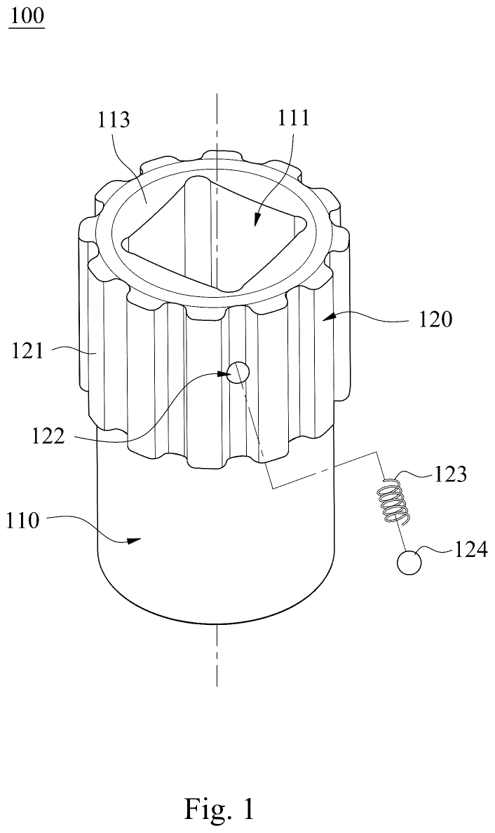

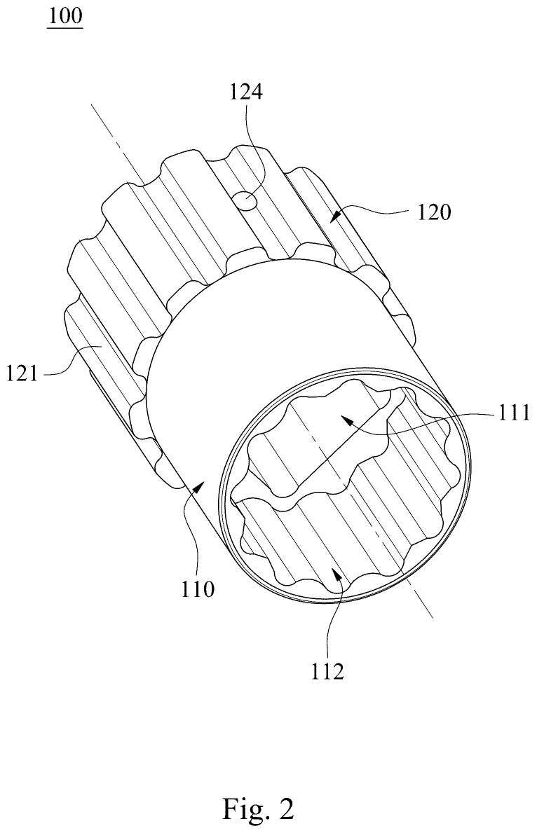

Please refer to FIG. 1 and FIG. 2. FIG. 1 is an exploded schematic view of a socket structure 100 according to the first example of the present disclosure. FIG. 2 is a three-dimensional schematic view of the socket structure 100 according to FIG. 1. The socket structure 100 includes a socket body 110 and a polygonal driving structure 120. The socket body 100 includes a first fitting hole 111 and a second fitting hole 112. The first fitting hole 111 is located at one end of the socket body 110 along a central axis of the socket structure 100. The second fitting hole 112 is located at the other end of the socket body 110 along the central axis of the socket structure 100. The first fitting hole 111 is communicated with the second fitting hole 112. The first fitting hole 111 can engage with hand tools such as a square wrench, and drive the socket structure 100 to pivot by the square wrench. The second fitting hole 112 can engage with fasteners such as screws.

The polygonal driving structure 120 is disposed around an outer peripheral wall of the socket body 110 and surrounding the first fitting hole 111. In detail, the socket body 110 can include a driving surface 113, the driving surface 113 can be perpendicular to the central axis, and the first fitting hole 111 can extend through the driving surface 113. The polygonal driving structure 120 can include a plurality of tooth portions 121, each one of the plurality of tooth portions 121 extends from the driving surface 113 in a direction parallel to the central axis. Also, each one of the plurality of tooth portions 121 can be a rectangular column with a long side parallel to the central axis. Therefore, the socket structure 100 having the plurality of tooth portions 121 can engage with a ratchet wrench to drive the socket structure 100 to pivot. The first fitting hole 111 and the polygonal driving structure 120 can respectively engage with different hand tools, so as to improve the diversity of driving the socket structure 100.

The socket structure 100 can further include a recessed space 122, an elastic member 123 and a positioning ball 124. The recessed space 122 is arranged at the polygonal driving structure 120 along a radial direction of the central axis. The elastic member 123 is arranged in the recessed space 122. The positioning ball 124 is connected to one end of the elastic member 123, and the positioning ball 124 is partially protruding from the recessed space 122. When a hand tool (not shown) engage with the polygonal driving structure 120, the position ball 124 can abut against a fitting hole of the hand tool, which is favorable for engaging and fixing to make the hand tool engage more stably.

In FIG. 2, a depth of the first fitting hole 111 and a depth of the second fitting hole 112 can be larger than heights of the hand tool or the fasteners to be engaged, so as to prevent the hand tool from exceeding the first fitting hole 111 and reaching the second fitting hole 112 when the hand tool engages with the first fitting hole 111, and push against the fasteners, causing the fasteners to be detached from the second fitting hole 112. However, the present disclosure is not limited thereto.

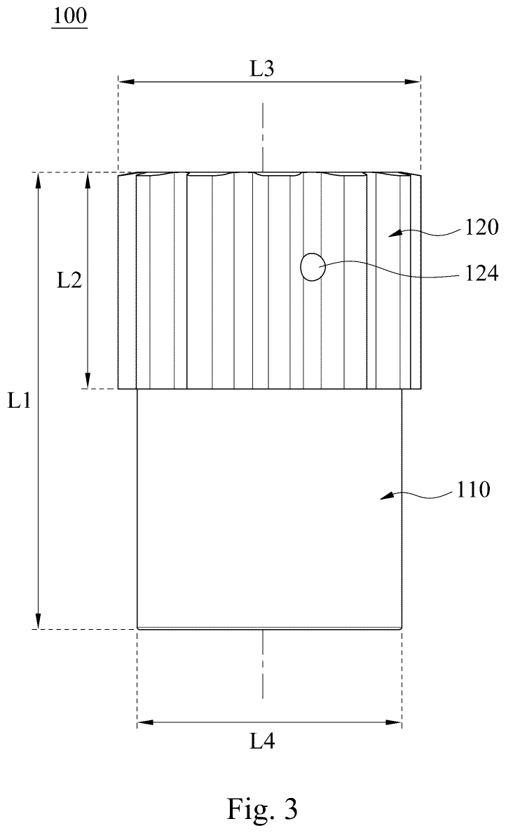

Please refer to FIG. 3. FIG. 3 is a side schematic view of the socket structure 100 according to FIG. 1. The socket structure 100 has a maximum height L1 along the central axis, the polygonal driving structure 120 has an axial height L2 along the central axis, and the axial height L2 is smaller than or equal to half of the maximum height L1. Furthermore, the axial height L2 can be between 34% and 42% of the maximum height L1. Therefore, it confirms that the socket body 110 and the polygonal driving structure 120 have a proper ratio.

In FIG. 3, the polygonal driving structure 120 has a first width L3 along the radial direction of the central axis. The socket body 110 has a second width L4 along the radial direction of the central axis, and the first width L3 is larger than the second width L4. Therefore, when using the ratchet wrench engaging with and driving the socket structure 100 to pivot, an effort arm can be larger than a load arm, and the effects of saving efforts can be achieved.

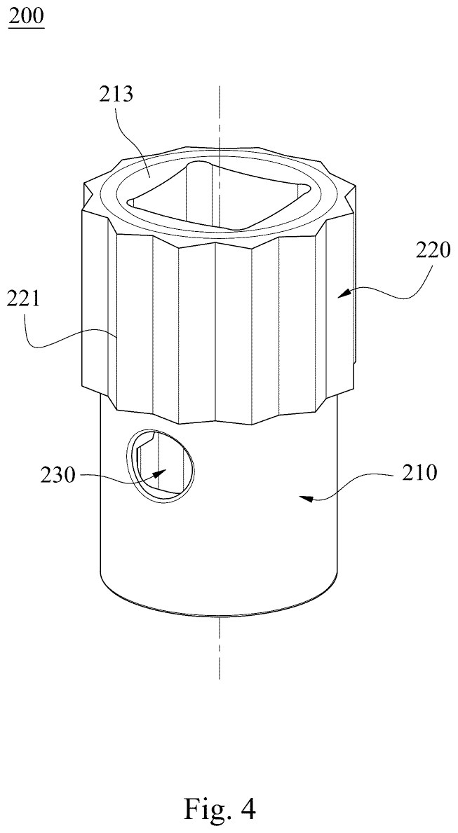

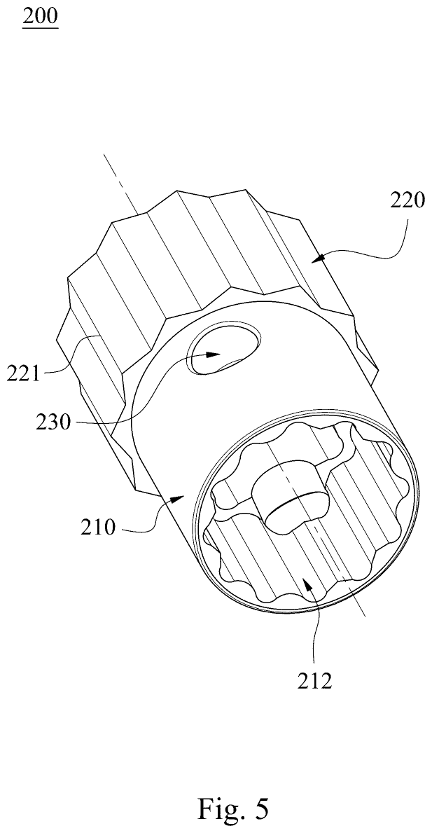

Please refer to FIG. 4 and FIG. 5. FIG. 4 is one three-dimensional schematic view of a socket structure 200 according to the second example of the present disclosure. FIG. 5 is another three-dimensional schematic view of the socket structure 200 according to FIG. 4. Configuration of a socket body 210 and a polygonal driving structure 220 in the socket structure 200 of FIG. 4 is similar to configuration of the socket body 110 and the polygonal driving structure 120 in the socket structure 100 of FIG. 1, and the similarities thereof are not repeated herein. It's noteworthy that, in the second example, each one of a plurality of tooth portions 221 of the polygonal driving structure 220 can be a triangular prism with sharp angle, causing an end surface of the polygonal driving structure 220 flush with a driving surface 213 to be a star polygon.

Moreover, the socket structure 200 can include a driving hole 230. The driving hole 230 extends through the socket body 210 and is communicated with a second fitting hole 212 along a radial direction of a central axis. The driving hole 230 can be configured for a hand tool (not shown) to engage with a side of the socket body 210, user can drive the socket structure 200 to pivot by giving the force at the side of the socket body 210. Therefore, in the space which has insufficient vertical height, the socket structure 200 can still be used to complete disassemble and assemble of a fastener.

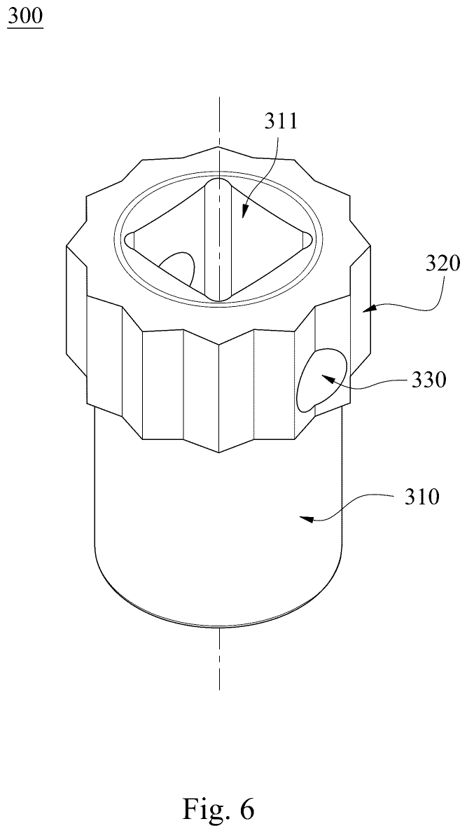

Please refer to FIG. 6, which is a three-dimensional schematic view of a socket structure 300 according to the third example of the present disclosure. Configuration of a socket body 310 and a polygonal driving structure 320 in the socket structure 300 of FIG. 6 is similar to configuration of the socket body 210 and the polygonal driving structure 220 in the socket structure 200 of FIG. 4, and the similarities thereof are not repeated herein. In particular, in the third example, a driving hole 330 extends through the polygonal driving structure 320 along a radial direction of a central axis, so as to communicate with a first fitting hole 311.

It should be noted that the diving hole 230 in the second example is communicated with the second fitting hole 212, and the diving hole 330 in the third example is communicated with the first fitting hole 311, that is, the arrangement of position of the driving holes 230, 330 can be changed according to actual needs, which is favorable for user to operate in different spaces, so the present disclosure is not limited to the aforementioned examples.

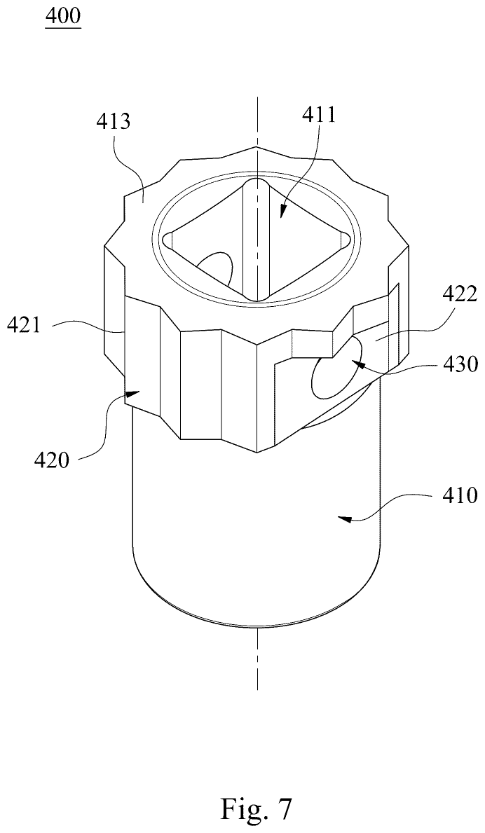

Please refer to FIG. 7, which is a three-dimensional schematic view of a socket structure 400 according to the fourth example of the present disclosure. Configuration of a socket body 410 and a polygonal driving structure 420 in the socket structure 400 of FIG. 7 is similar to configuration of the socket body 310 and the polygonal driving structure 320 in the socket structure 300 of FIG. 6, and the similarities thereof are not repeated herein. In particular, in the fourth example, the polygonal driving structure 420 can further include a stepped portion 422, the stepped portion 422 is recessed in at least one of a plurality of tooth portions 421, and extends upward from a lower edge of the polygonal driving structure 420, which can form a flat surface shown as FIG. 7. Also, the polygonal driving structure 420 which is adjacent to a driving surface 413 maintains complete polygonal structure, which can be configured for different hand tools to engage.

Furthermore, a driving hole 430 can extend through the stepped portion 422 of the polygonal driving structure 420 and the socket body 410 along a radial direction of a central axis, so as to communicate with a first fitting hole 411. The way of user making use of the driving hole 430 to drive the socket structure 400 to pivot is similar to that of the aforementioned socket structure 200 and the aforementioned socket structure 300, so the detail is not repeated herein. Moreover, the stepped portions 422 can be arranged at two opposite sides of the polygonal driving structure 420, which is configured for an open-end wrench to engage, so as to drive the socket structure 400 to pivot.

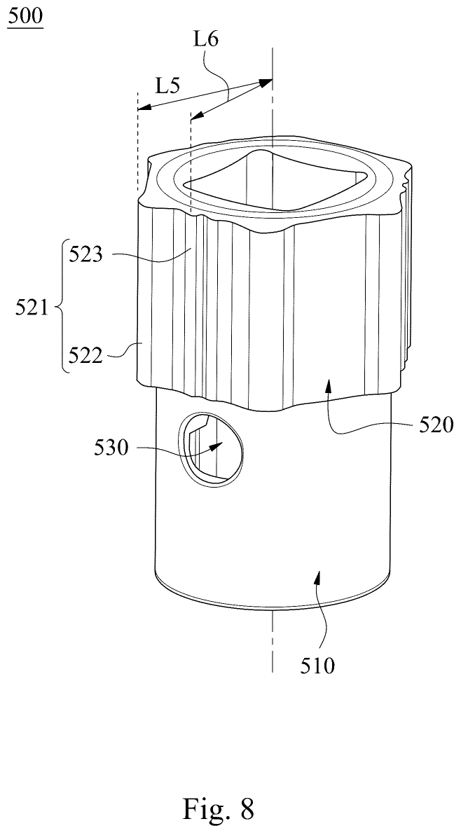

Please refer to FIG. 8, which is a three-dimensional schematic view of a socket structure 500 according to the fifth example of the present disclosure. Configuration of a socket body 510, a polygonal driving structure 520 and a driving hole 530 in the socket structure 500 of FIG. 8 is similar to configuration of the socket body 210, the polygonal driving structure 220 and the driving hole 230 in the socket structure 200 of FIG. 4, and the similarities thereof are not repeated herein. In particular, in the fifth example, a plurality of tooth portions 521 of the polygonal driving structure 520 can further include a plurality of first tooth portions 522 and a plurality of second tooth portions 523.

Furthermore, each one of the first tooth portions 522 has a first axial length L5 along a radial direction of a central axis, the second tooth portions 523 are connected to the first tooth portions 522, each one of the second tooth portions 523 has a second axial length L6 along the radial direction of the central axis, and the first axial length L5 is longer than the second axial length L6. By arranging the first tooth portions 522 and the second tooth portions 523, a friction between a ratchet wrench and the polygonal driving structure 520 can increase, so as to improve a firmness of engagement between the ratchet wrench to the socket structure 500.

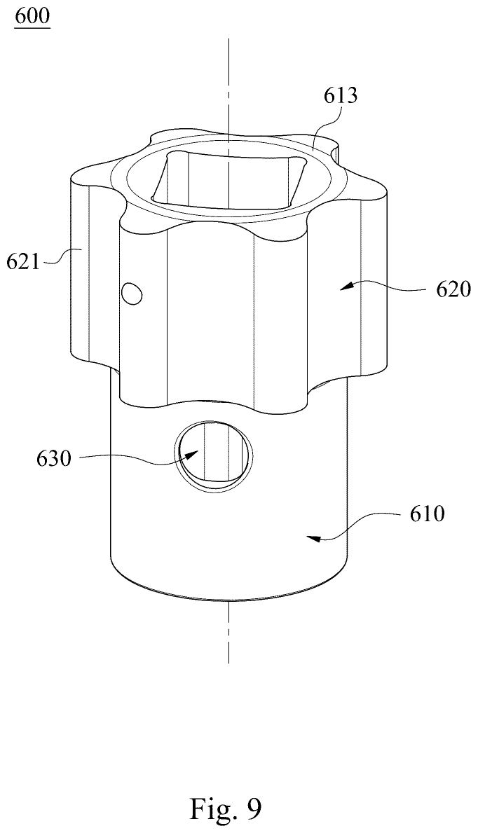

Please refer FIG. 9, which is a three-dimensional schematic view of a socket structure 600 according to the sixth example of the present disclosure. Configuration of a socket body 610, a polygonal driving structure 620 and a driving hole 630 in the socket structure 600 of FIG. 9 is similar to configuration of the socket body 210, the polygonal driving structure 220 and the driving hole 230 in the socket structure 200 of FIG. 4, and the similarities thereof are not repeated herein. In particular, the polygonal driving structure 620 includes six tooth portions 621, each of the tooth portions 621 can be a cylinder, and two of the tooth portions 621 which are adjacent to each other can be connected by a curve surface, causing an end surface of the polygonal driving structure 620 flush with a driving surface 613 to be a hexalobular, which is configured for different hand tools to engage, and the present disclosure is not limited thereto.

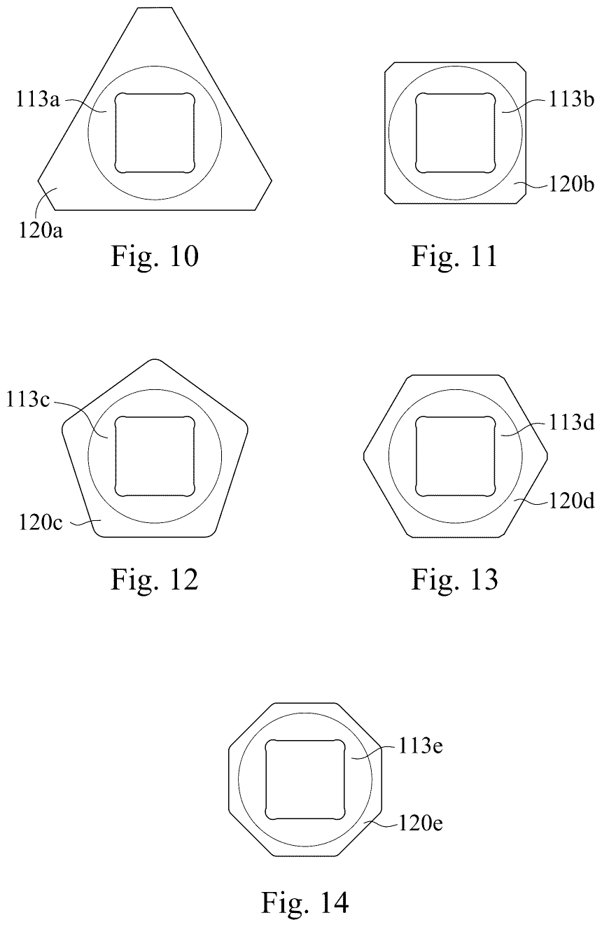

Please refer to FIG. 10, which is a top schematic view of a driving surface 113a and a polygonal driving structure 120a according to the seventh example of the present disclosure. The polygonal driving structure 120a includes three trapezoidal prism tooth portions (unnumbered), causing an end surface of the polygonal driving structure 120a flush with a driving surface 113a to be a triangle, and a side of each of the tooth portions away from a central axis forms a tangent plane.

Please refer to FIG. 11, which is a top schematic view of a driving surface 113b and a polygonal driving structure 120b according to the eighth example of the present disclosure. The polygonal driving structure 120b includes four trapezoidal prism tooth portions (unnumbered), causing an end surface of the polygonal driving structure 120b flush with a driving surface 113b to be a rectangle, and a side of each of the tooth portions away from a central axis forms a tangent plane.

Please refer to FIG. 12, which is a top schematic view of a driving surface 113c and a polygonal driving structure 120c according to the ninth example of the present disclosure. The polygonal driving structure 120c includes five obtuse triangular prism tooth portions (unnumbered), causing an end surface of the polygonal driving structure 120c flush with a driving surface 113c to be a pentagon, and a side of each of the tooth portions away from a central axis has a cross-sectional shape being an obtuse angle.

Please refer to FIG. 13, which is a top schematic view of a driving surface 113d and a polygonal driving structure 120d according to the tenth example of the present disclosure. The polygonal driving structure 120d includes six obtuse triangular prism tooth portions (unnumbered), causing an end surface of the polygonal driving structure 120d flush with a driving surface 113d to be a hexagon, and a side of each of the tooth portions away from a central axis has a cross-sectional shape being an obtuse angle.

Please refer to FIG. 14, which is a top schematic view of a driving surface 113e and a polygonal driving structure 120e according to the eleventh example of the present disclosure. The polygonal driving structure 120e includes eight obtuse triangular prism tooth portions (unnumbered), causing an end surface of the polygonal driving structure 120e flush with a driving surface 113e to be an octagon, and a side of each of the tooth portions away from a central axis has a cross-sectional shape being an obtuse angle.

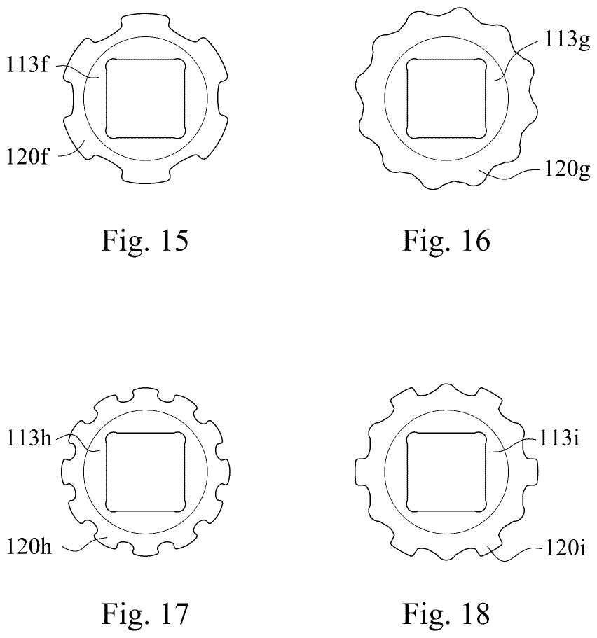

Please refer to FIG. 15, which is a top schematic view of a driving surface 113f and a polygonal driving structure 120f according to the twelfth example of the present disclosure. The polygonal driving structure 120f includes six rectangular prism tooth portions (unnumbered), and each of the tooth portions is disposed around an outer peripheral wall of the socket body (unnumbered) in equal parts.

Please refer to FIG. 16, which is a top schematic view of a driving surface 113g and a polygonal driving structure 120g according to the thirteenth example of the present disclosure. The polygonal driving structure 120g includes twelve cylinder tooth portions (unnumbered), and two of the tooth portions adjacent to each other can be connected by two planes, causing the two of the tooth portions adjacent to each other to form a folded plane which is recessed towards a central axis.

Please refer to FIG. 17, which is a top schematic view of a driving surface 113h and a polygonal driving structure 120h according to the fourteenth example of the present disclosure. The polygonal driving structure 120h includes twelve rectangular prism tooth portions (unnumbered), and two of the tooth portions adjacent to each other can be connected by a curved surface, causing a side of each of the tooth portions adjacent to a central axis to be recessed and form a neck portion.

Please refer to FIG. 18, which is a top schematic view of a driving surface 113i and a polygonal driving structure 120i according to the fifteenth example of the present disclosure. The polygonal driving structure 120i includes six cylinder tooth portions (unnumbered) and six rectangular prism tooth portions (unnumbered), and the cylinder tooth portions and the rectangular prism tooth portions are alternately disposed around an outer peripheral wall of a socket body (unnumbered).

It should be mentioned that, each technical feature in the previous examples of socket structures can be assembled and configured according to needs, and the corresponding effects can be achieved. In addition, a number and a shape of the tooth portions in the polygonal driving structures can be changed according to needs, so as to engage with hand tools which have fitting holes with corresponding shapes, and the present disclosure is not limited to the aforementioned examples.

In conclusion, the socket structure of the present disclosure, by setting the first fitting hole, the polygonal driving structure and the driving hole, can be configured for different types of hand tools to engage and drive the socket structure to pivot. User can depend on the operating environment and use single socket structure to cooperate with suitable hand tools, which improves the diversity of operating the socket structure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A socket structure, comprising:
a socket body comprising a first fitting hole and a second fitting hole, wherein the first fitting hole and the second fitting hole are respectively located at two ends of the socket body along a central axis of the socket structure, and the first fitting hole is communicated with the second fitting hole; and
a polygonal driving structure disposed around an outer peripheral wall of the socket body and surrounding the first fitting hole;
wherein the socket structure has a maximum height along the central axis, the polygonal driving structure has an axial height along the central axis, and the axial height is smaller than or equal to half of the maximum height.

2. The socket structure of claim 1, wherein the socket body comprises a driving surface, the driving surface is perpendicular to the central axis, and the first fitting hole extends through the driving surface;
the polygonal driving structure comprises a plurality of tooth portions, each one of the plurality of tooth portions extends from the driving surface in a direction parallel to the central axis.

3. The socket structure of claim 2, wherein the polygonal driving structure further comprises:
a stepped portion recessed in at least one of the plurality of tooth portions.

4. The socket structure of claim 2, wherein the plurality of tooth portions comprises:
a plurality of first tooth portions, each one of the plurality of first tooth portions has a first axial length along a radial direction of the central axis; and
a plurality of second tooth portions connected to the plurality of first tooth portions, wherein each one of the plurality of second tooth portions has a second axial length along the radial direction of the central axis, and the first axial length is longer than the second axial length.

5. The socket structure of claim 1, wherein the axial height is between 34% and 42% of the maximum height.

6. The socket structure of claim 1, further comprising:
a recessed space arranged at the polygonal driving structure along a radial direction of the central axis;
an elastic member arranged in the recessed space; and
a positioning ball connected to one end of the elastic member, and the positioning ball partially protruding from the recessed space.

7. A socket structure, comprising:
a socket body comprising a first fitting hole and a second fitting hole, wherein the first fitting hole and the second fitting hole are respectively located at two ends of the socket body along a central axis of the socket structure, and the first fitting hole is communicated with the second fitting hole;
a polygonal driving structure disposed around an outer peripheral wall of the socket body and surrounding the first fitting hole; and
a driving hole communicated with the first fitting hole or the second fitting hole along a radial direction of the central axis.

8. The socket structure of claim 7, wherein
the socket body comprises a driving surface, the driving surface is perpendicular to the central axis, and the first fitting hole extends through the driving surface;
the polygonal driving structure comprises a plurality of tooth portions, each one of the plurality of tooth portions extends from the driving surface in a direction parallel to the central axis.

9. The socket structure of claim 8, wherein the polygonal driving structure further comprises:
a stepped portion recessed in at least one of the plurality of tooth portions;
wherein the driving hole extends through the stepped portion of the polygonal driving structure and the socket body along the radial direction of the central axis, so as to be communicated with the first fitting hole.

10. The socket structure of claim 7, wherein the driving hole extends through the socket body, so as to be communicated with the second fitting hole.
